(19) United States
(12) Patent Application Publication
(10) Pub. No.: US 2014/0127464 A1
(43) Pub. Date: May 8, 2014

(54) Method For Producing A Conversion Element, And Conversion Element

(71) Applicants: Angela Eberhardt, Augsburg (DE); Reinhold Schmidt, Augsburg (DE); Harald Strixner, Oberottmarshausen (DE)

(72) Inventors: Angela Eberhardt, Augsburg (DE); Reinhold Schmidt, Augsburg (DE); Harald Strixner, Oberottmarshausen (DE)

(21) Appl. No.: 14/131,173

(22) PCT Filed: Jul. 4, 2012
(86) PCT No.: PCT/EP2012/063011

§ 371 Date: Jan. 6, 2014

(30) Foreign Application Priority Data
Jul. 5, 2011 (DE) 102011078663.5

(51) Int. Cl. C03C 4/12; C03C 17/22

(52) U.S. Cl. CPC C03C 4/12; C03C 17/22
USPC 428/141; 65/60.1; 428/174; 428/156; 65/60.2; 65/60.5; 428/426; 65/26; 428/98; 428/428; 252/301.4 R

(57) ABSTRACT

A method for producing a conversion element (10) for an optical and/or optoelectronic component (20), wherein the method comprises the following steps: a) applying phosphor (4; 4a) or a material (3a) which contains phosphor (4; 4a) to a surface (1A) of a transparent, phosphor-free, and homogeneous glass material (2a) and performance of a temperature treatment (TB1) at elevated temperature (T1) above the softening temperature (Tw) of the glass material (2a), wherein the glass material (2a) is softened enough that the phosphor (4; 4a) sinks into the glass material; (2a), and b) cooling the glass material (2a) including the sunken-in phosphor.

The invention relates to a method for producing a conversion element and a conversion element.

Conversion elements are used in conjunction with optical or optoelectronic components for the purpose of changing the spectrum and therefore the perceived color impression of the electromagnetic radiation emitted by the component. A conversion element is attached for this purpose in front of the component, for example, a light-emitting semiconductor chip, such that the radiation emitted by the component passes through the conversion element. Phosphors in the conversion element set the colorimetric locus and the color temperature.

Conventionally, the matrix material and the phosphor are mixed with one another during the production of a conversion element.

Silicone, in which the phosphor is suspended, is conventionally used as a matrix material. The suspension is then applied as a thin layer, for example, by screen printing. However, silicone is a poor heat conductor and is only capable of inadequately dissipating the heat arising during the operation of the light-emitting component, because of which the phosphor is then subjected to an elevated thermal stress and therefore loses efficiency.

Glass as a matrix material has the advantage of better heat conduction, since the heat conduction is higher by a factor of 10 in comparison to silicone on average, whereby the phosphors heat up less in operation and thus are more efficient. On the other hand, high temperatures are necessary for embedding the phosphor particles in the case of the use of glass as a matrix, whereby the phosphor can be damaged during this process and can thus also permanently lose efficiency.

DE 10 2008 021 438 A1 describes a method for producing a conversion element having glass matrix, in which a mixture of glass and phosphor is mixed, compacted, and sintered. During this sintering method, relatively high temperatures are used (150° C. above the softening temperature).

It is the object of the present invention to provide a conversion element and a method for the production thereof, using which the optical properties of the conversion element are improved and in particular glass materials are usable as a matrix material for a conversion element, in which the phosphor is damaged as little as possible or not at all. In relation to the commercially-available conversion elements, which contain silicone as a matrix material, improved heat dissipation is to be achieved during the operation of the conversion element.

This object is achieved by a method according to claim 1 and by a conversion element according to claim 11. In the method according to claim 1, the phosphor is not introduced into silicone, but rather into a glass material, since glass ensures particularly high heat dissipation in comparison to silicone. However, above all the phosphor is not already admixed with the matrix material (with the glass here) at the beginning of the production method. In particular, this avoids a material mixture made of phosphor and matrix material (powder material according to DE 10 2008 021 438 A1 or melt) from being subjected to a temperature treatment. Instead, a glass material in compact form is used; optionally as a preformed substrate or as a softened glass mass. The phosphor is only subsequently introduced into the softened glass material.

If a material mixture made of glass particles and phosphor particles were directly subjected to the temperature treatment step, which results in the melting and vitrification of the material mixture, the phosphor would be subjected to a very strong temperature stress (at high temperature and/or over a long duration). However, one of the considerations utilized in this application is that if a glass mass were already provided as a coherent glass body, thermal energy would no longer be necessary for melting together the glass particles to form a glass mass which is as bubble-free as possible. According to the invention, the phosphor is therefore not already mixed with glass material at the beginning of production, but rather a phosphor-free glass material is first used, which is initially only covered on its surface (for example, its top side) with phosphor or a phosphor-containing material. The driving of the phosphor into the glass material then occurs subsequently by sinking in at elevated temperature. The glass—in contrast to the sintering method from DE 10 2008 021 438 A1—is only heated sufficiently that the phosphor sinks into its surface. The temperatures required to obtain a bubble-free conversion element are lower here in the case of identical processing conditions (duration) at normal pressure (1013 mbar) than in the case of the sintering method. The glass can be provided as a solid glass substrate, which is still to be heated, or as a glass mass which is already heated and thus softened (in a pressing mold or casting mold).

The phosphor or the phosphor-containing layer is firstly applied to an outer side (for example, the top side) of the glass layer or the glass substrate and then only subsequently introduced into the homogeneous glass material by sinking in. Because of the lower temperature in comparison to the sintering method described in DE 10 2008 021 438 A1, the risk of production-related damage of the phosphor is therefore lower. This thus increases the usability of glass materials as an alternative to silicone in conversion elements.

The glass material not only forms an underlay for applying the phosphor or the phosphor-containing layer, but rather it is itself used as the actual base material for the conversion element, because the phosphor is introduced directly into the glass material by sinking in. The sinking in procedure can be assisted and accelerated by utilizing the force of gravity, by mechanical pressing, and/or by overpressure, respectively in conjunction with the heat action during the temperature treatment. The transparent glass substrate is heated beyond its softening temperature. The finished conversion element later contains sunken-in phosphor particles of one type of phosphor or a mixture of various types of phosphor in the glass material used as a matrix.

The glass material can be provided at room temperature before carrying out the temperature treatment and can be heated jointly with the layer containing phosphor applied on top. The glass mass is again softened, but only sufficiently that the phosphor sinks therein.

Alternatively, the temperature treatment of the glass material can be initiated before the phosphor is applied to the surface of the heated and softened glass material. For example, if the glass is produced from glass powder or from the melt, the coating with phosphor is thus first performed after the cooling of the bubble-free glass body thus obtained. Alternatively, the coating with phosphor and the sinking in of the phosphor can also occur during the cooling phase at a temperature above the softening temperature (optionally assisted by mechanical pressing or overpressure). According to ISO 7884-3, the softening temperature is defined at a viscosity η=10^{7.6} dPa·s. The alternative described here combines in one process glass molding, coating, and sinking in and saves the heating once again which is otherwise required to soften the glass. Already finished molded or commercially available glass bodies, for example, plane-parallel thin glass, ultrathin glass, lenses (concave, convex, etc.) or flasks can also be used for the production of such a conversion element. In this case, the glass body is coated with phosphor and then only heated enough that the phosphor sinks into the glass surface.

The point in time at which the phosphor or the phosphor-containing material is applied to the surface of the glass material can optionally be selected before or during the temperature treatment; the time sequence is flexible, however, it is dependent on the method by which the phosphor is applied, and also on the composition of the phosphor-containing material. If the phosphor-containing material is applied as a printable paste (for example, for screen printing and template printing), for example, the paste typically also contains, in addition to the phosphor particles, a solvent and a binder. In this case, the coating of the glass substrate is preferably performed before the heating, so that the vaporization of the solvent and the binder burnout can occur during the heating procedure. The phosphor-containing material can also be applied to the glass by spraying, painting, or spreading, by electrostatic deposition, or in another manner. The phosphor-containing material can contain the phosphor suspended in an organic solvent (for example, isopropanol).

Soft glasses or hard glasses, which are transparent, i.e., have a high transmission in the UV-visible range and a low intrinsic coloration, can be used as a glass. Furthermore, the use of low-melting-point glasses is also possible. For example, the borosilicate glass of designation D263T from the producer Schott, which is available as a thin glass, is suitable as a soft glass. Depending on the selection of the glass, the temperature, which is maintained or at least briefly reached at maximum during the temperature treatment, can be between 80° C. and 1500° C. Preferably, glasses are used, the softening temperature of which is not greater than 740° C., so that the phosphor can still be caused to sink into the glass surface at temperatures below 800° C. (optionally with the aid of mechanical pressing or by overpressure). For example, hard glasses or soft glasses having a softening temperature of between 600 and 950° C. can be used. The temperature stress is even significantly less upon the use of low-melting-point glass.

According to one refinement, it is provided that additionally a further layer made of further glass material is applied. This glass material is preferably the same as the glass material covered with phosphor in step a); however, another glass material (for example, a thin glass or ultrathin glass having deviating material composition) can also be used. The laminate is produced according to method steps c) to e), i.e., preferably by a further temperature treatment.

The performance of steps c) to e) according to the above refinement suggests itself in particular if two different or heterogeneous phosphors are to be sunk into the glass material by sinking in. In this case, the first phosphor is introduced into the glass material treated in step a), while in contrast the second phosphor is introduced in the layer of the further glass material (for example, into a second glass substrate in the form of a thin glass or ultrathin glass). Both types of phosphor are thus also spatially separated from one another after the sinking in; a type of laminate of multiple partial layers made of glass materials provided with different phosphor types and/or phosphor concentrations results. The positions of the maximum concentration of the first phosphor type and the second phosphor type are spaced apart from one another in the direction of the layer thickness of the conversion element, for example, by a distance which corresponds approximately to the thickness of the thin glass or ultrathin glass which is laid on subsequently.

Alternatively, the further phosphor can also be applied in a separate method step to the opposing surface of the glass material (which was previously already treated on one side using phosphor). Furthermore, different types of phosphor can also be provided in one coating as a mixture. In a further embodiment, two separately produced conversion elements are connected to one another using the two phosphor-containing surfaces.

Several exemplary embodiments will be described hereafter with reference to the figures. In the figures:

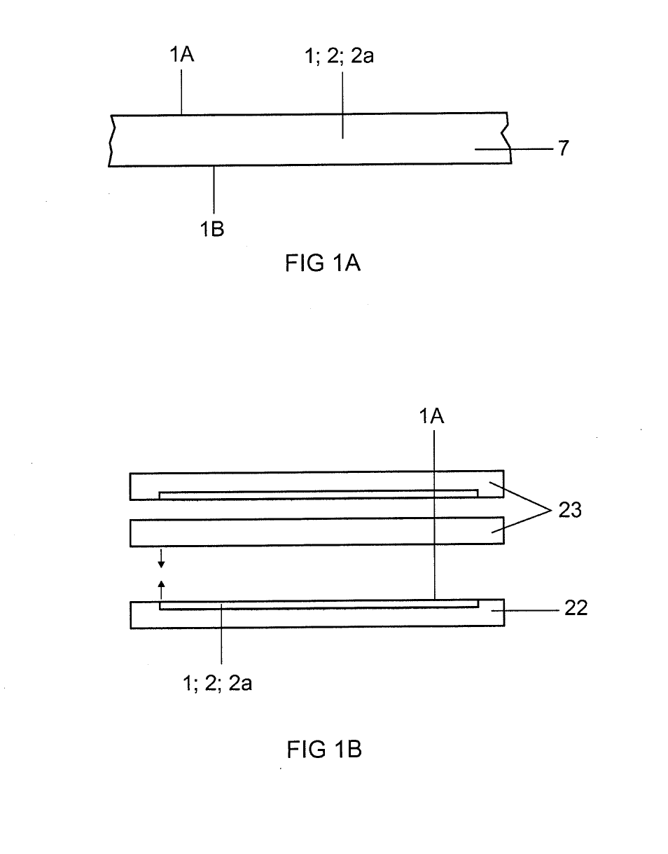

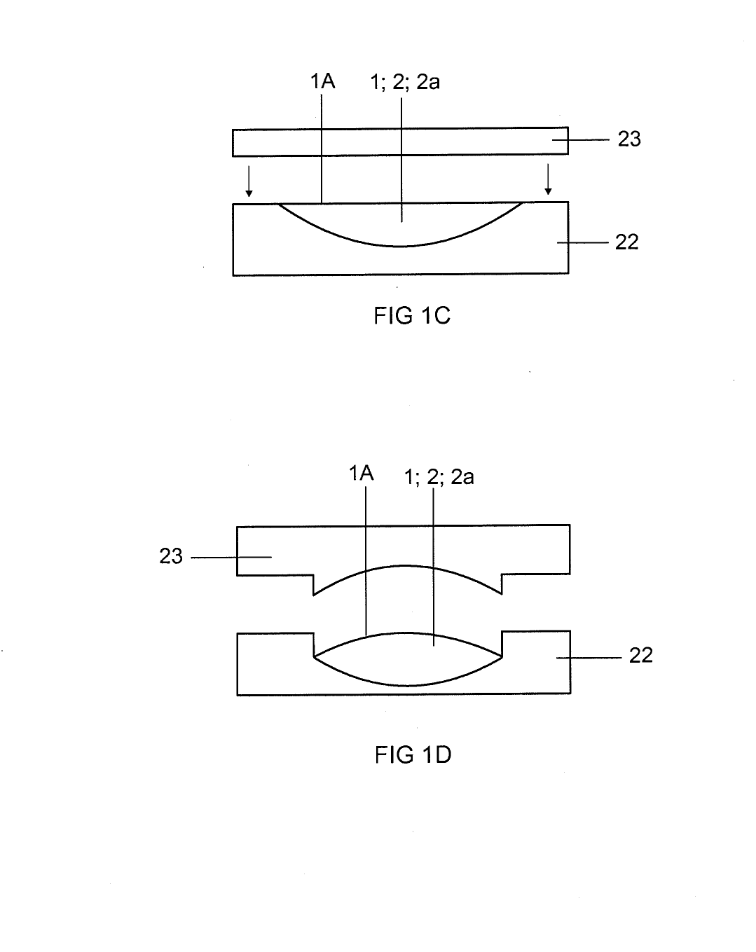

FIGS. 1A to 1D show various proposals for molding a glass to be used for the described method,

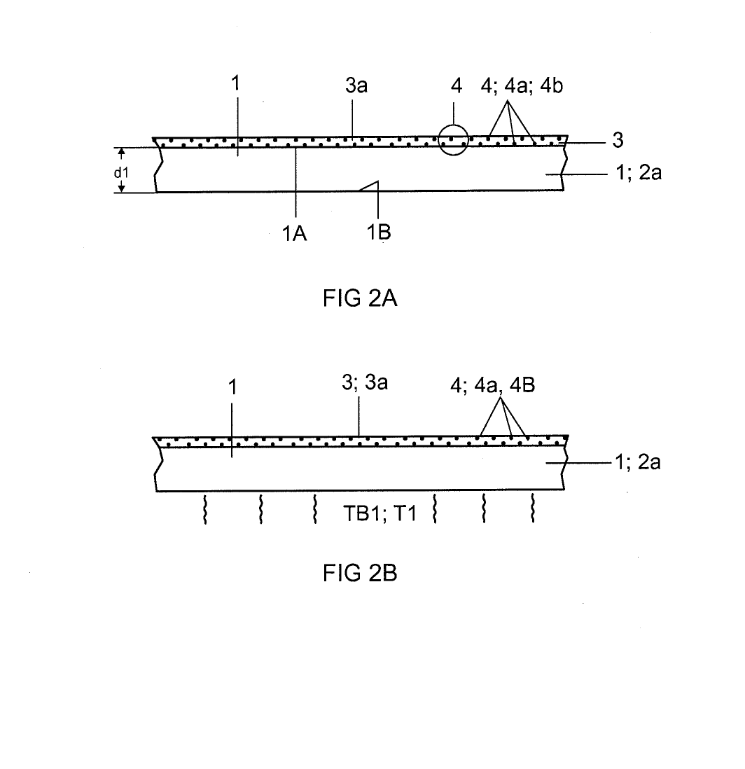

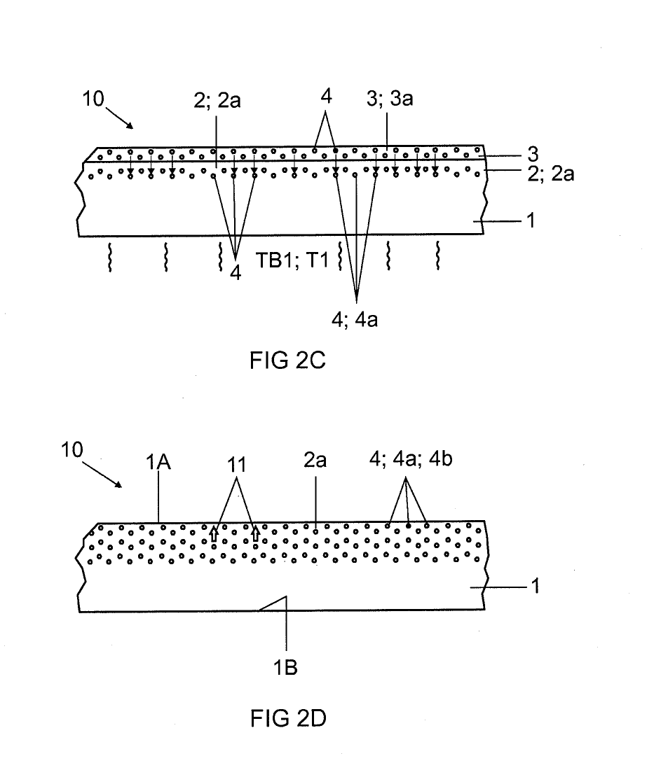

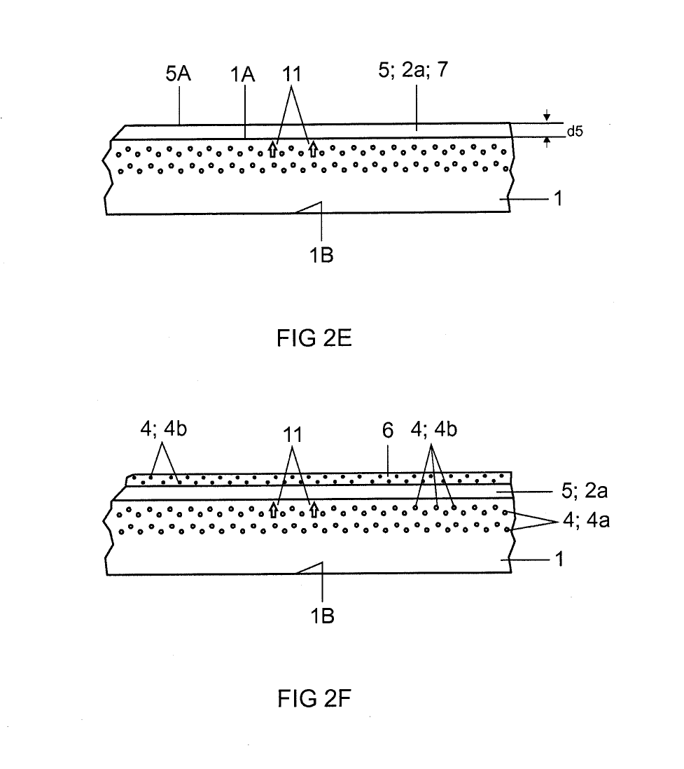

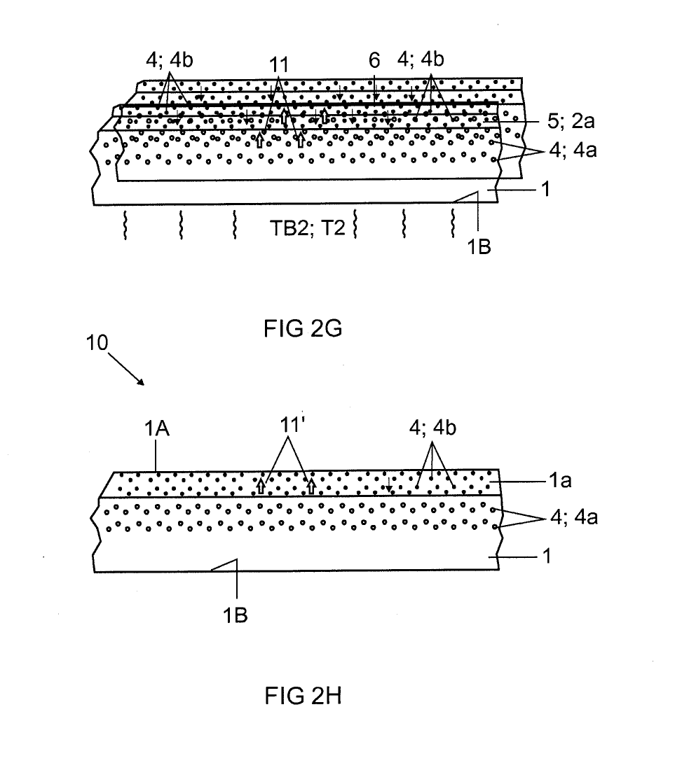

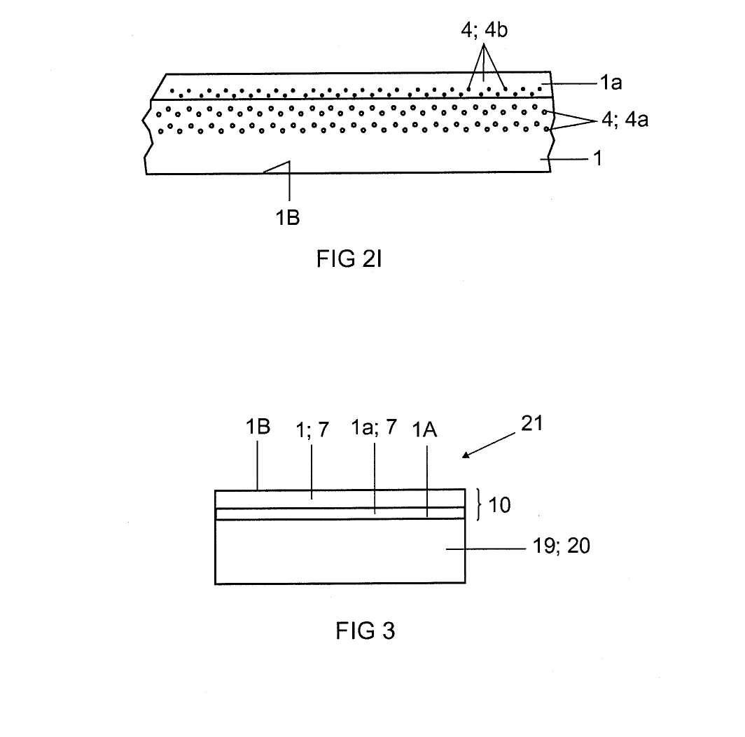

FIGS. 2A to 2I show various method steps of one type of embodiment of the proposed production method for a conversion element, and

FIGS. 3 to 7 show various exemplary embodiments of arrangements each having one conversion element and at least one optical or optoelectronic component.

For the performance of the method proposed here for producing a conversion element, firstly phosphor-free glass material is used; for example, according to one of FIGS. 1A to 1D. According to FIG. 1A, the glass material 2a is used in the form of a solid, pre-molded glass substrate 1. The glass substrate 1 can be in particular a thin glass 7 or ultrathin glass, which has a layer thickness less than 1.0 mm, for example, between 5 and 100 μm, in particular between 5 and 50 μm.

According to FIG. 1B, a mold 22 can be used as an underlay for such a glass substrate, which is also used for heating, i.e., for softening the glass mass 2, and for the shaping. Phosphor or a phosphor-containing material is then applied, preferably before the heating, to the upper surface 1A of the glass substrate 1 according to FIG. 1A or the glass mass 2 according to FIG. 1B. Alternatively, the mold can also be coated with phosphor, which thus simultaneously acts as a parting agent. Since the glass contracts during softening as a result of the surface tension, it is to be held in shape by a pressing mold 23 during the temperature treatment. Alternatively, it can also only be brought into shape during the cooling procedure.

FIG. 1B also shows, in addition to the mold 22 used as the underlay, two different pressing molds 23. One of the two pressing molds 23 is used for the shaping during the cooling procedure, i.e., pressed against the mold 22, so that the softened glass, which is provided with the sunken-in phosphor, maintains its external shape (corresponding to the recesses in the mold parts 22, 23) during the cooling. The mold 22 and the pressing mold 23 can both be coated with phosphor, so that it sinks into both surfaces of the glass in particular. In comparison thereto, one of the two surfaces can also be coated with other particles, for example, ceramic particles, which also sink in and later scatter the light. The optical index of refraction of these particles preferably differs by 0.1 or more from that of the glass. The glass material 2a supported by the mold 22 according to FIG. 1B can also be a thicker glass. The upper pressing mold 23 from FIG. 1B (having recess) is preferably used for this purpose. The recesses in the mold 22 and in the pressing mold 23 then jointly determine the design of the cooling glass body. If a thin or ultrathin glass substrate is used, the recess in the mold 22 is sufficient; in this case, the lower pressing mold 23 from FIG. 1B (without recess) is preferably used.

Alternatively to a finished molded glass substrate, the mold 22 can also be used for the shaping in that it is filled with a glass melt. In this case, the glass typically has a viscosity in the range of η=10² to 10⁴ dPa·s. The glass mass 2 to be covered with phosphor additionally does not have to be a plane-parallel layer, but rather can also be provided according to FIG. 1C as a lenticular (cooled or heated) glass body in a correspondingly shaped mold 22.

To introduce phosphor into a curved top side 1A of a lenticular or otherwise curved structural shape of the glass body, as shown in FIG. 1D, a multipart arrangement made of a bottom mold 22 and a top pressing mold 23 can be used, wherein the pressing mold 23 is at least temporarily, preferably at least during the cooling procedure, pressed against the mold 22 during the performance of the temperature treatment, to ensure the desired shaping during the cooling of the glass material 2a. As long as the pressing mold 23 has not yet engaged in the mold 22, the curved surface 1A is accessible for the application of the phosphor.

The glass material 2a, which is provided according to one of FIGS. 1A to 1D or in another manner, and which forms the starting material for the method, is therefore a homogeneous, compact, coherent and phosphor-free (and otherwise transparent) glass mass, which is also as bubble-free as possible. In comparison to the sintering method described in DE 10 2008 021 438 A1, the glass is already provided bubble-free here and is only still softened sufficiently that the phosphor sinks into the surface thereof. This is typically performed at lower temperatures than in the case of the sintering method, since the phosphor particles have a viscosity-increasing effect and thus the air enclosed between the powder particles can first escape at higher temperatures or upon targeted use of partial vacuum. The bubble fraction (porosity) is, inter alia, an important constant for the emission characteristic of the conversion element. To achieve the same light color, the thickness of the conversion element increases with increasing porosity. This results in amplified emission toward one side (for example, as a “yellow ring”) and thus more inhomogeneous light distribution over the angle. The advantage of the method described here is that the phosphor only sinks into the surface and is thus provided more concentrated thereon, i.e., is distributed inhomogeneously in the vertical direction (in the direction of the layer thickness). This surface is preferably positioned close to the chip, so that the phosphor is seated as closely as possible to the chip. The region on which the sunken-in phosphor is provided is therefore smaller than that in the homogeneously distributed sintered part. Garnets (for example, YAG:Ce, LuAG, etc.), nitrides, SiONs, and/or orthosilicates are usable as a phosphor, using which various colorimetric loci can be set. The conversion element described here can also be used in combination with a conversion ceramic as a laminate, also having another light color. The phosphor-rich side of the glassy conversion element is also preferably provided close to the chip in this case, i.e., close to the ceramic (wherein the ceramic is arranged between the chip and the glassy conversion element). In this embodiment, the glassy conversion element and the conversion ceramic can also be glued directly to one another with the aid of a further temperature treatment (similarly to TB2). The conversion elements can be attached both directly on the chip and also at a distance to the chip (remote phosphor) and can be used both for partial conversion and also for complete conversion.

The conversion elements can be fastened as is typical using silicone, using a low-melting-point glass, or by means of sol-gel on the chip and also to one another. The glass for the performance of the method steps described hereafter can optionally be provided in an already heated state or as an initially cold, pre-molded glass body.

According to FIG. 2A, a layer 3 made of a phosphor-containing material 3a is applied to the surface 1A of the glass mass. The glass mass can be, for example, a level, plane-parallel glass substrate 1 (as in FIGS. 1A and 1B) or a glass body molded in another manner, for example, lenticular (as in FIG. 1C or 1D) or flask-shaped (as in FIG. 7). The glass mass, which is used according to FIGS. 2A to 2I as a substrate 1, can also be a preheated glass mass 2a, which is heated in particular beyond the softening temperature thereof, but is not yet free-flowing (FIG. 1C or 1D). The various conceivable forms of appearance of the glass material 2a are no longer differentiated hereafter, and for the sake of brevity, reference is only still made to the glass substrate 1. As in all remaining figures, the dimension ratios, in particular the schematically shown layer thicknesses, are not to scale.

According to FIG. 2B, a temperature treatment TB1 is performed at a temperature T1 above the softening temperature of the glass material 2a, wherein the maximum temperature T1 only has to be reached during a part of the duration of the temperature treatment TB1. The temperature treatment TB1 can be performed after the application of a layer 3 made of phosphor 4 or phosphor-containing material 3a, but can also be initiated already during or before the application of the phosphor-containing material. In the case in which the temperature treatment TB1 is initiated before or during the application, only phosphor powder without further additives is preferably to be applied to the glass material 2a.

The layer 3 applied according to FIGS. 2A or 2B contains a phosphor 4, which is contained in the form of solid particles in a suspension or solution. The phosphor 4 can comprise one or more different types of phosphor 4a, 4b, to produce various colorimetric loci. If phosphor is again applied during later method steps (FIG. 2F), preferably only one single type of phosphor 4, specifically 4a, is applied according to FIGS. 2A and 2B.

FIG. 2C schematically shows the sinking in of the phosphor 4 during the temperature treatment TB1. From the layer 3 made of the material 3a containing the phosphor 4, 4a, the phosphor particles gradually sink into the surface of the glass substrate 1 or into the heated glass mass 2. This sedimentation, which is caused by the force of gravity, can be assisted and accelerated by mechanical pressing, for example, with the aid of a pressing mold 23 from FIG. 1D. The glass substrate 1 or the mass of the glass material 2a is admixed with the phosphor 4 by the sinking in of the phosphor (illustrated in FIG. 2C by the arrows pointing downward).

FIG. 2D schematically shows the distribution of the phosphor 4 within the glass substrate 1; preferably, the phosphor is predominantly concentrated with respect to quantity on or close to the top surface 1A in the glass material 2a, i.e., it is distributed inhomogeneously. The gradient 11 of the phosphor concentration within the layer thickness of the glass substrate 1 points in the direction of the first, top surface 1A; the concentration of the phosphor 4a assumes a local maximum at or just below the surface 1A.

According to a refinement from FIG. 2E, still further glass material can be applied and provided with further phosphor later. The glass substrate 1 treated according to FIG. 2D represents an already finished conversion element 10 per se (after the cooling), however, which can be assembled with one or more optoelectronic components or semiconductor chips.

The conversion element 10 from FIG. 2D can also first still be subjected to further processing steps. For example, a further phosphor 4 (for example, a different phosphor 4b than the phosphor applied in FIG. 2A) can be applied from the opposing surface 1B and introduced into the glass substrate 1 by sinking in from the surface 1B by way of a second temperature treatment. For the application and sinking in of the further phosphor 4b, the conversion element 10 from FIG. 2D is turned over, so that the surface 1B points upward.

According to an alternative refinement, which is shown in FIGS. 2E to 2H, a layer 5 of the layer thickness d5 made of further glass material 2a can be applied to the same surface 1A (according to FIG. 2E) and can also be covered with a further layer 6 made of phosphor-containing material on its top side 5A, which is then exposed (according to FIG. 2F). In particular, a different phosphor 4; 4b is applied in this case than that which was previously applied according to FIG. 2A. The layer 5, which is covered in this manner with further phosphor 4; 4b can be, for example, a thin glass 7 or ultrathin glass, the layer thickness of which is preferably less than 1.0 mm and in particular can be between 5 μm and 100 μm, preferably between 5 μm and 50 μm. Subsequently, according to FIG. 2G, a second temperature treatment TB2 is performed at a temperature T2, to introduce the further phosphor 4b by sinking into the layer 5 made of the further glass material 2a, as indicated in FIG. 2G by the arrows pointing downward.

In this manner, the conversion element 10 schematically shown in FIG. 2H results, which has, over the first-treated glass substrate 1, a further partial layer 1a made of phosphor-containing glass (made of either the same or another base material, and also the phosphor 4; 4b). In practice, the original glass substrate 1 and the partial layer la are fused to form a unified glass layer of the conversion element 10.

Nonetheless, the previous interface between the substrate 1 or the lower partial layer made of phosphor-containing glass and the upper partial layer la made of further phosphor-containing glass is shown as a partition line in FIG. 2H and the further following figures, to identify the profile of the phosphor concentration in the interior of the conversion element 10. The conversion element 10 from FIG. 2H forms a type of laminate, in which the first phosphor 4a is concentrated in the direction of the layer thickness of the conversion element at a position between two partial layers 1, 1a. The top partial layer 1a is preferably thinner than the bottom partial layer or the earlier glass substrate 1, so that the concentration of the first phosphor 4a is also closer to the surface 1A than to the opposite surface 1B. Thus, as in FIG. 2D, the concentration of the first-introduced phosphor particles 4a increases with decreasing distance from the surface 1A, i.e., the later interface to the top partial layer 1a (as indicated by the gradient 11), according to FIG. 2H, the concentration of the sunken-in further phosphor 4b also increases with decreasing distance from the exposed top side 1A (as indicated by the gradient 11′). Therefore, when the partial layers 1 and 1a of the conversion element 10 are fused with one another, the previous interface between them approximately forms the position of the maximum concentration of the first phosphor 4a, while in contrast the maximum concentration of the second phosphor 4b is at the surface 1A of the conversion element 10, i.e., at the earlier surface 5A of the previously applied layer 5 (FIG. 2E). In the conversion element 10 obtained according to FIG. 2H, the first and the second phosphors 4a, 4b are therefore spatially separated from one another.

Alternatively, however, two separately produced conversion elements, into each of which phosphor 4 was introduced from one surface by sinking in, can also be connected to one another. The two conversion elements can be fastened on one another with their two phosphor-containing surfaces in particular. The assembled conversion element shown in FIG. 2I thus results, in which both the concentration of the (first) phosphor 4; 4a within the partial layer 1 and also the concentration of the (second) phosphor 4; 4b within the partial layer 1a respectively increases toward the interface between the two partial layers 1, 1a.

FIGS. 3 to 7 show exemplary embodiments of a conversion element 10, which is assembled with at least one optical and/or optoelectronic component 20, in particular a semiconductor chip 19. The upper surface 1A in FIG. 2H, in which the concentration of the phosphor 4b is greatest, is connected to the component 20 according to FIG. 3. From the opposing surface 1B, the concentration of the first phosphor 4a increases with increasing proximity to the component 20. The conversion element 10 can also consist solely of the glass substrate 1 (for example, a thin glass 7) alone; the partial layer 1a made of phosphor-containing glass is then omitted, so that the conversion element 10 corresponds to that from FIG. 2D. However, if the partial layer la is provided, it is preferably a thin glass 7 or ultrathin glass. The first-processed glass substrate 1 (or the partial layer of the glass material resulting therefrom) does not have to be a thin glass.

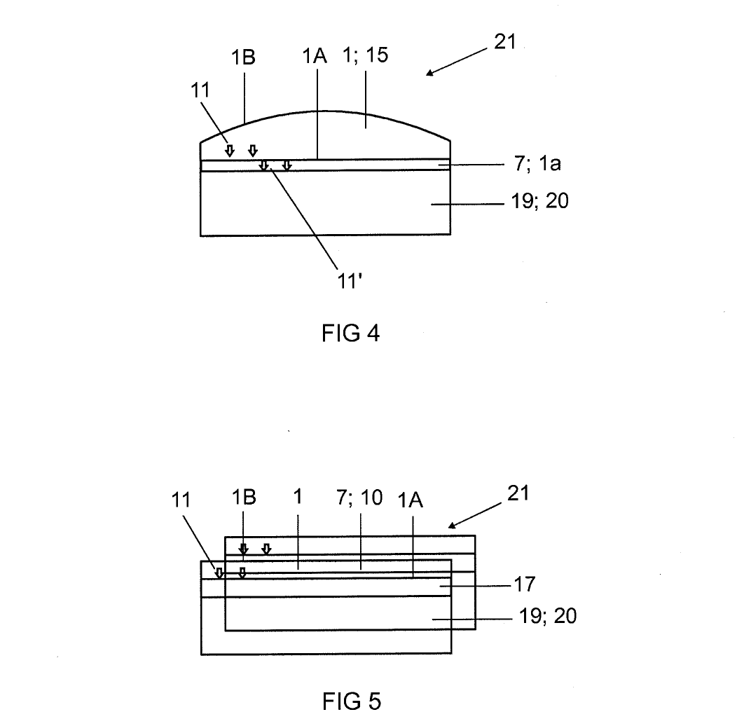

In particular, the substrate 1 can be formed as an optical lens 15 as in FIG. 4 and can have a curved (rear) surface 1B. In FIG. 4, the gradients 11 and 11′ of the concentrations of the first and the second phosphors 4a, 4b are shown, which each point toward the component 20. As in FIG. 3, the thin glass 7 or the partial layer la can be omitted.

FIG. 5 shows an embodiment of an arrangement 21, which also has a ceramic conversion layer 17 between the glass substrate 1 and the component 20. The ceramic conversion layer 17 can contain a different phosphor than the glass substrate. A ceramic conversion layer has a higher heat conduction than a glass substrate, but has the disadvantage that only phosphors for specific colors or spectral ranges can be introduced. The ceramic conversion layer can have a layer thickness between 50 and 300 μm, preferably between 100 and 200 μm, or also less than 100 μm (for example, greater than 50 μm).

The glass substrate 1 can be a thin glass or ultrathin glass (having the bandwidth already mentioned in this application for its layer thickness), but can also be a thicker, plane-parallel glass (having a layer thickness up to 2 mm) or alternatively a glass shaped as an optical element (as in FIG. 4 or in another manner).

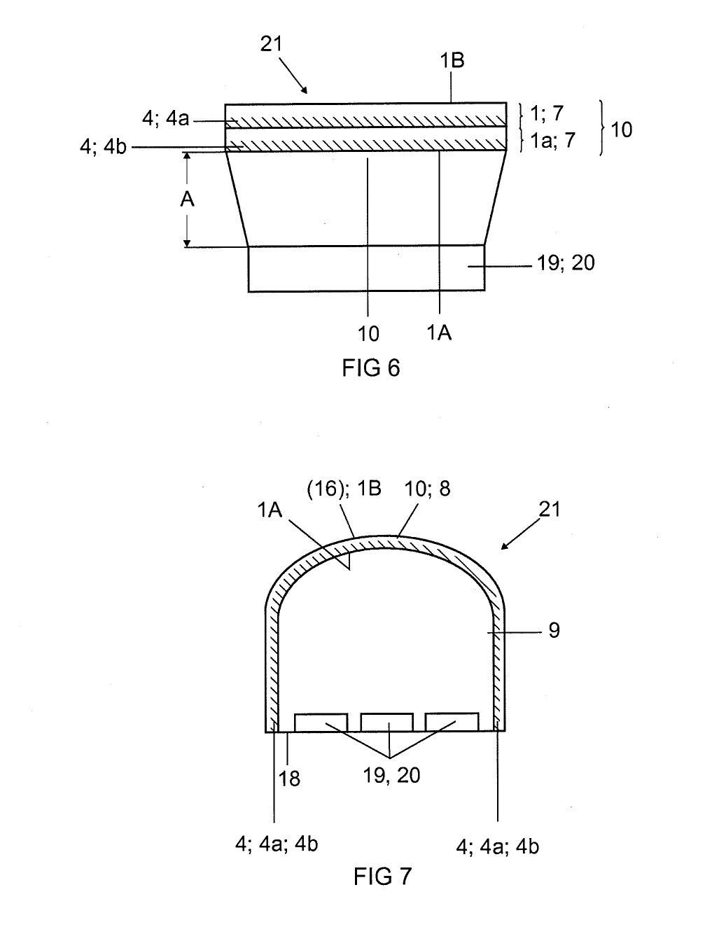

FIG. 6 shows an embodiment in which the conversion element 10 is arranged spaced apart at a distance A from the optoelectronic component 20 or semiconductor chip 19. The conversion element 10 is constructed, for example, like that from FIG. 3, i.e., having two different partial layers 1, 1a each having a concentration of the respective phosphor 4a or 4b, respectively, increasing toward the semiconductor chip 19. The increasing phosphor concentration is shown in FIG. 6 by shaded lower regions of the respective layer 1, 1a (instead of by gradient arrows 11, 11′ as in FIG. 4). Both layers 1, 1a can respectively represent a thin glass 7 or ultrathin glass (having the bandwidth already mentioned in this application for its layer thickness). Preferably, at least the lower partial layer 1a is a thin glass or ultrathin glass. The conversion element 10 can be held using a reflector or another frame at the distance A from the semiconductor chip 19. The conversion element 10 can also be composed such that all phosphors 4a, 4b have their maximum phosphor concentration at the bottom surface 1A, facing toward the semiconductor chip 19; correspondingly, the partial layer 1a (and the vertical offset thus caused between the maximum concentrations of the respective phosphors 4a, 4b) would be omitted.

FIG. 7 shows an embodiment in which the conversion element 10 is formed as a flask-shaped glass body 8.

The glass body 8 is shaped concavely on the surface 1A at which the concentration of the phosphor 4 is greatest (indicated by shading), and therefore encloses a cavity 9. The opposing, low-phosphor surface 1B points convexly outward and can be roughened (chemically and/or mechanically) or covered with an optional scattering layer 16. This scattering layer can also be provided on the conversion elements 10 of all other embodiments, in particular those of FIGS. 2D, 2H, and 3 to 6. In FIG. 7, optionally one single or also multiple semiconductor chips 19 or components 20, which each emit electromagnetic radiation, can be arranged on a carrier plate 18. In particular in the case of a plurality of components 20, an improvement of the emission characteristic is achieved with the aid of the roughening or the scattering layer 16. The conversion element 10 is arranged spaced apart from the optoelectronic components 20, wherein the surface 1A of maximum phosphor concentration, from which the phosphor 4 was introduced into the glass material, faces toward the components 20. In FIGS. 6 and 7, respectively a first conversion element can alternatively also be installed directly on the chip or the plurality of chips and a second conversion element, in particular one having a different phosphor, can also be arranged spaced apart (as shown).

Hard glasses, soft glasses, or even low-melting-point (in particular lead-free) glasses can be used for the conversion element proposed in the application. For the case in which the conversion element is fastened on the chip or is used in combination with a ceramic conversion element, glasses having a coefficient of thermal expansion a (20-300° C.) between 6×10⁻⁶/K and 20×10⁻⁶/K, ideally between 8×10⁻⁶/K and 12×10⁻⁶/K are preferably used. If a glass is used, the optical index of refraction of which is similar to that of the sunken-in phosphor (for example, having an index of refraction nD approximately at 1.8 in the case of garnets), the efficiency of the optical component can thus be increased once again. The conversion element can then be fastened on the component with a phosphor-free silicone layer, a layer made of low-melting-point glass, or by means of a sol-gel method.

If a lead-free, low-melting-point glass (having a softening temperature approximately between 400 and 600° C.) is used as the glass material instead of a soft glass or hard glass (having softening temperatures between 650 and 950° C.), this glass can contain as the main component a zinc-containing borate glass, a zinc-bismuth-borate glass, an aluminum phosphate glass, an aluminum-zinc-phosphate glass, or an alkali phosphate glass. The use of so-called low Tg glasses, for example, P-PK53 from Schott, the Tg of which is typically at most 550° C., is also possible. For example, a garnet (for example, YAG:Ce, LuAG, etc.), a nitride, an SiON, and/or an orthosilicate is usable as a phosphor for sinking into the hard glass, soft glass, or low-melting-point glass. In addition, multiple different types of phosphors can be used in combination with one another, to produce two or more different secondary spectra or a specific colorimetric locus. A first phosphor can be introduced into a first partial layer of the conversion element 10 and a second, different phosphor can be introduced into a second, different partial layer of the conversion element.

With the aid of the sinking in of a phosphor performed thereafter according to the invention, in particular an inhomogeneous distribution of the respective phosphor may be produced in the direction of the layer thickness of the glass or glass material. The distribution of the phosphor can be homogeneous in the direction parallel to the surfaces 1A, 1B of the conversion element. Alternatively, an inhomogeneous phosphor distribution can also be provided in the lateral direction. For this purpose, the phosphor in FIGS. 2A and 2F is to be applied inhomogeneously to the surface of the glass material. By suitable selection of the lateral phosphor distribution, the emission characteristic may be influenced in a targeted manner. As an additional measure or alternatively thereto, the conversion element of FIGS. 2D, 2H, or 3 to 7 can be roughened on one surface 1A or provided with a scattering layer. Thus, the emission characteristic can be improved in a conversion element, which is spaced apart from the component, in spherical shape or hemispherical shape. This causes more uniform color distribution, for example, in retrofit lamps having multiple components (in particular of different light colors) below the conversion element.

1. A method for producing a conversion element for an optical and/or optoelectronic component, wherein the method comprises at lost the following steps:
a) applying phosphor or a material which contains phosphor to a surface of a transparent, phosphor-free, and homogeneous glass material and performance of a temperature treatment at elevated temperature above the softening temperature of the glass material, wherein the glass material is softened enough that the phosphor sinks into the glass material; and
b) cooling the glass material including the sunken-in phosphor.

2. The method as claimed in claim 1,
wherein the phosphor or the material containing the phosphor is applied, by spraying, spreading, painting, electrostatic deposition, by printing of a pasty layer, or in another manner, directly onto the surface of the glass material or as a parting agent on a mold or pressing mold intended for shaping of the glass material.

3. The method as claimed in claim 1,
wherein the glass material is covered as a compact, coherent, and bubble-free glass layer with the phosphor or with the material containing the phosphor and subjected to the temperature treatment.

4. The method as claimed in claim 3,
wherein the compact, coherent, and bubble-free glass layer is provided in a state which is not yet heated, and is softened by the temperature treatment.

5. The method as claimed in claim 1, wherein,
wherein firstly the glass material is provided as a pre-molded solid glass substrate and is covered with the phosphor or with the material containing the phosphor, before the temperature treatment is performed.

6. The method as claimed in claim 1, wherein,
firstly the temperature treatment of the glass material is initiated, before the phosphor is applied to the surface of the softened or at least heated glass material.

7. The method as claimed in claim 1, further comprising,
before, during, and/or after the cooling of the glass material the steps of:
c) applying a layer made of a further glass material onto the glass material treated in step a);
d) applying further phosphor or a layer containing further phosphor onto a surface of the further layer, wherein the surface faces away from the glass material treated in step a);
e) introducing the further phosphor into the surface, which faces away, of the further glass material by sinking in at elevated temperature.

8. The method as claimed in claim 7,
wherein the further glass material is applied to the side of the glass material treated in step a) which is already covered with phosphor, and is provided in steps d) and e) with a different phosphor than the glass material treated in step a).

9. The method as claimed in claim 1, further comprising,
before, during, and/or after the cooling of the glass material the steps of:
c) applying further phosphor or a layer containing further phosphor onto a further, opposing surface of the glass material treated in step a); and
d) introducing the further phosphor into the second, opposing surface by sinking in at elevated temperature.

10. The method as claimed in claim 1, wherein the glass material used in step a) or c) is a plane-parallel thin glass or ultrathin glass having a glass thickness of between 5 μm and 1000 μm, or a flask-shaped glass body having a cavity on one side, or a lens.

11. A conversion element for an optical and/or optoelectronic component, wherein the conversion element comprises:
a transparent glass substrate, which is layered or molded in another manner,
wherein the glass substrate has at least one planar or curved first surface and one planar or curved second surface, opposite to the first surface, between which the glass substrate has a constant or varying layer thickness,
wherein the conversion element is formed from a glass material, which contains phosphor,
wherein the phosphor is distributed inhomogeneously in the direction of the layer thickness of the conversion element, and
wherein the concentration of the phosphor has a local maximum at a first surface of the two surfaces and decreases in the direction toward the second, opposing surface.

12. The conversion element as claimed in claim 11,
wherein the conversion element is roughened, matted, or covered with a scattering layer on the second, opposing surface of the glass substrate.

13. The conversion element as claimed in claim 11,
wherein the glass material of the conversion element contains two different phosphors, of which a first phosphor is concentrated in a first position between the two surfaces in the direction of the layer thickness of the conversion element, while in contrast a second phosphor is predominantly concentrated at a first surface of the two surfaces of the conversion element, or in a second position, which lies between the first surface and the first position in the direction of the layer thickness.

14. The conversion element as claimed in claim 13,
wherein the first surface of the glass substrate is molded to be planar or concave, and the distance between the first surface and the position of the maximum concentration of the second phosphor, measured in the direction of the layer thickness of the conversion element, is less than 1.0 mm.

15. The conversion element as claimed in claim 11, wherein the conversion element is installed onto a ceramic conversion layer or onto an optical and/or optoelectronic component, using the first surface, at which the concentration of the phosphor has a local maximum.

16. The method as claimed in claim 1, wherein the glass material used in step a) or c) is a plane-parallel thin glass or ultrathin glass having a glass thickness of between 5 μm and 500 82 m, or a flask-shaped glass body having a cavity on one side, or a lens.

17. The conversion element as claimed in claim 13,
wherein the first surface of the glass substrate is molded to be planar or concave, and the distance between the first surface and the position of the maximum concentration of the second phosphor, measured in the direction of the layer thickness of the conversion element, is less than 200 μm.

18. The conversion element as claimed in claim 11, wherein the conversion element is glued onto a ceramic conversion layer or onto a semiconductor chip using the surface, at which the concentration of the phosphor has a local maximum.
